(19) United States
(12) Patent Application Publication
(10) Pub. No.: US 2024/0274848 A1
(43) Pub. Date: Aug. 15, 2024

(54) FLUORINATED IONOMERS, POLYMER ELECTROLYTE MEMBRANES, FUEL CELLS, AND METHODS

(71) Applicants: 3M Innovative Properties Company, St. Paul, MN (US); Colorado School Of Mines, Golden, CO (US); GM Global Technology Operations LLC, Detroit, MI (US)

(72) Inventors: Michael A. Yandrasits, Hastings, MN (US); Matthew J. Lindell, Woodbury, MN (US); Arne Thaler, Neuss (DE); Andrew M. Herring, Boulder, CO (US); ChulOong Kim, Lakewood, CO (US); Mei-Chen Kuo, Denver, CO (US); Craig S. Gittleman, West Bloomfield, MI (US)

(21) Appl. No.: 18/566,288

(22) PCT Filed: Jun. 3, 2022
(86) PCT No.: PCT/US2022/032187

§ 371 Date: Dec. 1, 2023

Related U.S. Application Data
(60) Provisional application No. 63/197,289, filed on Jun. 4, 2021.

(51) Int. Cl. H01M 8/1039; C08F 214/26; C08J 5/22; H01M 8/10; H01M 8/1023

(52) U.S. Cl. CPC H01M 8/1039; C08F 214/262; C08J 5/225; H01M 8/1023; C08J 2327/18; H01M 2008/1095; H01M 2300/0082

(57) ABSTRACT

Fluorinated ionomers (i.e., ion conducting polymers) that include a fluorinated polymer backbone with covalently bound pendent groups that include heteropolyacid (HP A) groups, or salts thereof, and perfluorosulfonic acid (PF SA) groups, or salts thereof, as well as polymer electrolyte membranes, fuel cells, and methods.

### CROSS REFERENCE TO RELATED APPLICATIONS

This application claims the benefit of U.S. Provisional Application No. 63/197,289, filed 4 Jun. 2021, the disclosure of which is incorporated by reference herein in its entirety.

### STATEMENT OF GOVERNMENT RIGHTS

This invention was made with government support under DE-EE0008821 awarded by the Department of Energy. The government has certain rights in the invention.

### BACKGROUND

Fuel cells have been used to produce electrical energy for many years; however, commercial use of fuel cells as a source of power has been eclipsed by inexpensive, readily available fossil fuels. The use of fuel cells as a power source was renewed when a clean, reliable, and compact source of electrical energy was needed for satellites and spacecraft. Fuel cells are being considered again as an energy source as the global community faces diminishing fossil fuel reserves and environmental concerns related to their use. Fuel cells typically generate power more efficiently and cleaner than fossil fuel combustion.

Fuel cell technology is diverse and includes, for example, polymer electrolyte membranes, such as proton exchange membranes (PEMs), and solid oxide fuel cells. Polymer electrolyte membrane fuel cells show promise as an automotive power source, particularly if the polymer electrolyte membrane fuel cell can be made less expensive, more durable, reduce or eliminate humidification of the reactive gases, and operate at temperatures encountered during automotive operating conditions.

A heteropoly acid (HPA) is a class of acid consisting of a three-dimensional framework of oxygen, hydrogen, metals, and non-metals. A typical HPA structure is shown in FIG. 1. These inorganic cage structures are known to be both strong acids and peroxide decomposition catalysts. These materials have been attached to both hydrocarbon and fluorocarbon backbones to form a new class of ion conducting polymers (ionomers) with inherent peroxide decomposition properties. Unfortunately, practical membranes are difficult to fabricate from these polymers.

Perfluorosulfonic acid (PFSA) ionomers have been known since the late 1960s and have found wide application, especially in polymer electrolyte membranes in fuel cells. An exemplary PFSA ionomer has the following structure:

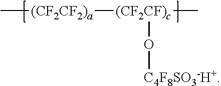

Due to electrochemical stability requirements, perfluorinated materials have been preferred as the best candidates for satisfying the needs of the system. Especially for automotive applications, the demand for materials for high-temperature operation, in the range of 80° C. and up to 120° C. with reduced reactant humidification, increased since the second half of the 1990s. Perfluorosulfonic acid (PFSA) membranes used in fuel cells are known to chemically degrade over time. Reactions with hydrogen peroxide (H₂O₂), hydroxyl radicals (HO·), or other reactive species can decompose the membrane polymer into fluoride, carbon dioxide, sulfate, small molecule ions and fragments, thereby limiting the lifetime of the membrane. Peroxide scavengers such as cerium or manganese ions are effective stabilizing additives that result in dramatic lifetime increases in accelerated and normal test conditions. These ions, however, can migrate within the PFSA membrane, leaving regions of the active area depleted of stabilizers. Therefore, there is a need for a stabilizing additive that is unable to migrate within the ion-conducting membrane.

### SUMMARY OF THE DISCLOSURE

The present disclosure provides fluorinated ionomers (i.e., ion conducting polymers), polymer electrolyte membranes (particularly, cation exchange membranes such as proton exchange membranes (PEMs)), fuel cells, and methods. The fluorinated ionomers include a fluorinated polymer backbone with covalently bound pendent groups that include heteropolyacid (HPA) groups, or salts thereof, and perfluorosulfonic acid (PFSA) groups, or salts thereof.

In one embodiment, the present disclosure provides a fluorinated ionomer (i.e., ion conducting polymer) comprising a fluorinated polymer backbone and pendent groups comprising: covalently bound heteropolyacid groups, or salts thereof, and covalently bound perfluorosulfonic acid groups, or salts thereof; wherein the perfluorosulfonic acid groups, or salts thereof, are present in an amount of at least 40 mol % of the total amount of pendent groups.

In another embodiment, the present disclosure provides a polymer electrolyte membrane comprising the fluorinated ionomer, and in another embodiment, a fuel cell comprising the polymer electrolyte membrane.

In another embodiment, the present disclosure provides a method of making the fluorinated ionomer described herein, the method comprising: providing a precursor polymer comprising vinylidene fluoride monomeric units, tetrafluoroethylene monomeric units, and trifluoroethylene monomeric units with pendent groups comprising covalently bound perfluorosulfonyl fluoride groups; hydrolyzing the perfluorosulfonyl fluoride groups to form covalently bound perfluorosulfonate salt groups; optionally ion exchanging the perfluorosulfonate groups to form perfluorosulfonic acid groups; attaching a functional entity (FG-L) to the precursor polymer; and attaching a lacunary heteropolyacid, or salt thereof, to the functional entity to form covalently bound heteropolyacid groups, or salts thereof.

The terms “polymer” and “polymeric material” include, but are not limited to, organic homopolymers, copolymers, such as for example, block, graft, random, and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other claims may also be preferred, under the same or other circumstances. Furthermore, the recitation of one or more preferred claims does not imply that other claims are not useful and is not intended to exclude other claims from the scope of the disclosure.

In this application, terms such as “a,” “an,” and “the” are not intended to refer to only a singular entity, but to include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Accordingly, unless otherwise indicated to the contrary, the numerical parameters set forth in the specification and claims are approximations that may vary depending upon the desired properties sought to be obtained by the present disclosure. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. All numerical values, however, inherently contain a range necessarily resulting from the standard deviation found in their respective testing measurements.

Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the term “room temperature” refers to a temperature of 20° C. to 25° C. or 22° C. to 25° C.

The term “in the range” or “within a range” (and similar statements) includes the endpoints of the stated range.

Groupings of alternative elements or embodiments disclosed herein are not to be construed as limitations. Each group member may be referred to and claimed individually or in any combination with other members of the group or other elements found therein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### BRIEF DESCRIPTION OF THE FIGURES

FIG. 1 is a typical heteropoly acid (HPA).

FIG. 2 is ATR-IR data of Comparative Preparatory Example 1 showing the loss of the 1465 cm⁻¹ peak and the formation of the 1060 cm⁻¹ peak, indicating the sulfonyl fluoride is hydrolyzed to sodium sulfonate.

FIG. 3 is ATR-IR data of Preparatory Example 6 showing the loss of the 1465 cm⁻¹ peak and the formation of the 1060 cm⁻¹ peak, indicating the sulfonyl fluoride is hydrolyzed to sodium sulfonate.

FIG. 4 is FTIR-ATR data (4A) and NMR data (4B) for HPA attachment, solid line indicates intermediate polymer with DHPP ((OH)(C₆H₄)(P═O)(OC₂H₅)₂) attachment on anchoring group and dashed line indicates final polymer with HPA chemically bound to the starting polymer.

FIG. 5 are ¹H NMR (5A) and ³¹P NMR (5B) data; solid line indicates intermediate polymer with DHPP attachment on anchoring group and dashed line indicates final polymer with HPA chemically bound to the starting polymer.

### DETAILED DESCRIPTION OF ILLUSTRATIVE EMBODIMENTS

The present disclosure provides fluorinated ionomers (i.e., ion conducting polymers), polymer electrolyte membranes (particularly, cation exchange membranes such as proton exchange membranes (PEMs)), fuel cells, and methods. The fluorinated ionomers include a fluorinated polymer backbone with covalently bound pendent groups that include heteropolyacid (HPA) groups, or salts thereof, and perfluorosulfonic acid (PFSA) groups, or salts thereof. Such ionomers utilize HPA groups, or salts thereof, and PFSA groups, or salts thereof, to provide high quality films with covalently bonded, immobilized, peroxide scavenging additives.

### Ionomers

In one embodiment, the present disclosure provides a fluorinated ionomer (i.e., ion conducting polymer) comprising a fluorinated polymer backbone and pendent groups including: covalently bound heteropolyacid groups, or salts thereof, and covalently bound perfluorosulfonic acid groups, or salts thereof. Such fluorinated ionomer can be used in a polymer electrolyte membrane, which can be used in a fuel cell.

The perfluorosulfonic acid groups, or salts thereof, are present in an amount of at least 40 mol % of the total amount of pendent groups. In certain preferred embodiments, the pendent groups include: 10-39 mol % covalently bound heteropolyacid groups, or salts thereof, and 61-90 mol % covalently bound perfluorosulfonic acid groups, or salts thereof, wherein the percentages are based on the total amount of pendent groups.

The covalently bound heteropolyacid groups, or salts thereof, are primarily present for peroxide scavenging and enhancing durability, and possibly to enhance proton conductivity; the sulfonic acid groups, or salts thereof, provide a major amount of ion conductivity (preferably, proton conductivity). If the covalently bound heteropolyacid groups, or salts thereof, are the only ionically conductive groups present, there is a tendency for the ionomer to aggregate into isolated domains, which inhibits its conductivity activity, at least because aggregated isolated domains of covalently bound heteropolyacid groups, or salts thereof, do not provide continuous ion conducting channels.

The heteropoly acid groups are derived from heteropolyacids (HPA's), which are a class of acid made up of a combination of acidic hydrogen atoms, transition metals, non-metal heteroatoms, and oxygen atoms coordinating the metal and non-metal atoms (either metal-oxygen-metal or metal-oxygen-non-metal linkages) forming a three-dimensional structure (e.g., a cluster).

The general structure of an HPA is as follows (Formula I):

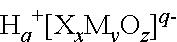

wherein H is hydrogen, each X is independently a non-metal heteroatom, each M is independently a transition metal, O is oxygen, “q” typically ranges from 2 to 30, “x” typically ranges from 1 to 3, “y” typically ranges from 5 to 25, and “z” typically ranges from 20 to 130.

Preferably, the transition metals M are selected from the group of tungsten, molybdenum, vanadium, tantalum, niobium, manganese, cerium, and combinations thereof. Preferably, the non-metal heteroatoms X are selected from the group of Groups 13 (Boron group), 14 (Carbon group), 15 (Nitrogen group), 16 (Oxygen group) of the Periodic Table, and combinations thereof. More preferably, the non-metal heteroatoms X are selected from the group of silicon, phosphorus, arsenic, and combinations thereon.

The HPA groups may be in acid form or they may be in salt form wherein the protons are ion-exchanged by other countercations such as Na, K, Li, Ca, Mn, Ce, ammonium, and substituted ammonium (e.g., tetramethyl ammonium). Thus, an HPA or salt thereof, has the following general structure (Formula II):

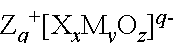

wherein: each Z is independently selected from the group of H, Na, K, Li, Ca, Mn, Ce, ammonium, and substituted ammonium (e.g., tetramethyl ammonium); each X is independently a non-metal heteroatom; each M is independently a transition metal; O is oxygen; p is 2 to 30; x is 1 to 3; y is 5 to 25; and z is 20 to 130. Preferably, X and M are as listed above for Formula I, and each Z is independently H, Li, Na, or K.

The HPA will decompose at high pH so any ions would have to be exchanged at neutral pH or lower.

The conjugate anions of the HPA's are referred to as polyoxometalate anions. Examples of HPA's and polyoxometalate anions are described in U.S. Pat. No. 9,240,287 (Stanis et al.). Two of the better-known groups of these —X^{m+}M₁₂O₄₀^{(8-m)-} and X₂^{m+}M₁₈O₆₂^{(16-2m)-}—are based on the Keggin, H_{q}XM₁₂O₄₀, and Wells-Dawson, H_{q}X₂M₁₈O₆₂, structures. In a preferred embodiment, the pendent heteropolyacid groups, or salts thereof, are derived from lacunary structures (a structure missing one or more atoms). Examples of lacunary heteropolyacids include, but are not limited to, X^{m+}M₁₁O₃₉^{(12-m)-}, X^{m+}M₁₀O₃₆^{(12-m)-}, X^{m+}M₉O₃₄^{(14-m)-}, X₂^{m+}M₁₇O₆₁^{(16-2m)-} and X₂^{m+}M₁₅O₅₆^{(18-2m)-} In certain embodiments, the pendent sulfonic acid/salt groups have the following structure (Formula III):

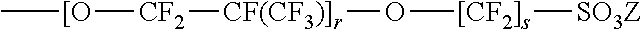

wherein “r” is 0 or 1, and “s” is 1 to 4, and Z is selected from the group of H, Na, K, Li, Ca, Mn, Ce, ammonium, and substituted ammonium (e.g., tetramethyl ammonium).

Typically, the pendent heteropolyacid groups, or salts thereof, are covalently bound to the fluorinated polymer backbone through a functional entity. Examples of suitable functional entities are described in U.S. Pat. No. 9,240,287 (Stanis et al.).

In one aspect, the precursor polymer is reacted with a linking group of a functional entity to form a functionalized polymer precursor. A lacunary HPA, or salt thereof, is contacted and reacted with a functional group of the functional entity to form a covalently bonded HPA, or salt thereof. The functional entity (FE) commonly has the following generalized formula (Formula IV):

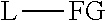

wherein FG is a reactive functional group and L is a linking group. The functional entity FE can be supplied or prepared by commonly known synthetic procedures.

More specifically, the reactive functional group FG chemically reacts with and forms a chemical bond with one of the oxygen or non-metal heteroatoms X of a lacunary HPA, or salt thereof. Preferably, the reactive functional group FG chemically reacts with the lacunary HPA, or salt thereof, to form a chemical bond with the oxygen of the EPA anion. Examples of preferred chemical bonds linking the HPA, or salt thereof, with the reactive functional group FG, comprise, without limitation, —O—Si—, —O—P—, —O—Sn—, —O—Ti—, —O—Ge— and —O—Zr— It can be appreciated that, the oxygen in the chemical bond linking the HPA, or salt thereof, to the reactive functional group FG is substantially covalently bonded to the HPA, or salt thereof. Additionally, it can be appreciated that, one of the silicon, phosphorous, tin, titanium, germanium, or zirconium, in the chemical bond linking the HPA, or salt thereof, to the reactive functional group FG, comprises, respectively, a portion of the of the functional entity FE that is substantially covalently bonded to the linking group L.

Preferably, the reactive functional group FG reacts with at least one oxygen of the HPA, or salt thereof. In some instances, the reactive functional group FG reacts with one or more oxygens of HPA, or salt thereof, to form a plurality of chemical bonds linking the HPA (or plurality of HPAs), or salt thereof, with the reactive functional group FG.

It can be appreciated that the covalently bonded HPA, or salt thereof, can have one or more functional entities chemically bonded thereto. Preferably, the average number of functional entities chemically bonded to the covalently bonded HPA, or salt thereof, preferably ranges from 1 to 4, more preferably 1 to 2, and even more preferably is in a 1 to 1 ratio (of reactive functional groups FG per covalently bonded HPA, or salt thereof). Stated another way, preferably at least 0.2% of the mass of the covalently bonded HPA, or salt thereof, comprises the functional entities FE (or FG-L) chemically bonded thereto. More preferably, at least 0.5%, more preferably at least 5% of the mass of the covalently bonded HPA, or salt thereof, comprises the functional entities FE bonded to the covalently bonded HPA, or salt thereof.

The linking group L is generally any alky, aryl, or combinations thereof radical. Alkyl radical generally means any straight-chained, branched, or cyclic, saturated or unsaturated hydrocarbon entity typically comprising carbon and hydrogen. The alkyl radical, preferably, has from 1 to 25 carbon atoms, Generally, the alkyl radical atomic mass ranges from 14 to 700 atomic mass units. Aryl radical generally means any linear, branched, or cyclic (aromatic or pseudo-aromatic) hydrocarbon entity typically comprising carbon and hydrogen. Generally, the aryl radical atomic mass ranges from 40 to 800 atomic mass units and from 4 to 50 carbon atoms. It can be appreciated that, alkyl and aryl radicals can optionally include one or more chemical substituents having oxygen, sulfur, nitrogen, chlorine, bromine, fluorine, or combinations thereof.

The linking group is capable of forming a covalent bond when contacted and reacted with the precursor polymer (i.e., the precursor polymer comprising vinylidene fluoride monomeric units, tetrafluoroethylene monomeric units, and trifluoroethylene monomeric units with pendent groups comprising covalently bound perfluorosulfonyl fluoride groups). The linking group can react directly with the precursor polymer Preferably, the linking group comprises, without limitation, amine, thiol, aniline, olefin, vinyl, styrenyl, or alcohol entity.

In one embodiment, the functional entity (FE or FG-L) is a silane generally represented by the following formula (Formula V):

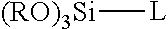

wherein (RO)₃Si corresponds to the functional group FG of the above general Formula IV. In one embodiment, RO comprises a hydrolysable alkyloxy group, such as, but not limited, to methoxy, ethoxy, or acetoxy. The hydrolysable group reacts and bonds with the lacunary HPA, or salt thereof, to form the covalently bonded HPA, or salt thereof. Preferably, at least one of the hydrolysable groups of the functional entity depicted in Formula V reacts with one of the oxygens of the lacunary HPA, or salt thereof, to form covalently bonded HPA, or salt thereof. While not wanting to be bound by any theory, the hydrolysable group RO of the functional entity reacts with one of the oxygens of the lacunary HPA, or salt thereof, to form one or more covalent bonds generally comprising at least in part, —Si—O—, linking the functional entity and the lacunary HPA, or salt thereof, to form the covalently bonded HPA, or salt thereof.

The L of Formula V corresponds to the linking group of general Formula IV. In other words, the linking group of Formula V is preferably a radical comprising alkyl, aryl, or combinations thereof. More preferably, the linking group L of Formula V is selected from the group consisting essentially of ethyl, propyl, and phenyl, and an organofunctional group capable of forming a covalent bond when contacted and reacted with the precursor polymer. Preferably, the linking group L of Formula V comprises one of amino, vinyl, styrenyl, aniline, olefin, alcohol, and thiol. More preferably, the linking group L is a primary amine, or vinyl, or styrenyl. Even more, preferably, the linking group L is a primary amine capable of being converted to a diazonium.

Suitable non-limiting examples silane functional entities are: vinyl tri(methoxyethoxy)silane, aminopropyltriethoxy silane, aminopropyltrimethoxy, aminopropylmethyldiethoxy silane, aminopropylmethyldi-methoxy silane, aminomethylaminopropyltrimethoxy silane, amino ethylaminopropyltriethoxy silane, aminoethylaminopropylmethyldimethoxy silane, diethyelenetriamino-propyltrimethoxy silane, diethyenetriaminopropyltriethoxy silane, hexanediamino-nethyltriethoxy silane, diethyenetriaminopropylnethyldirnethoxy silane, diethyenetriaminopropylnethydiethoxy silane, methacryloxypropyltrimethoxy silane, methacryloxypropyltriethoxy silane, nethacryloxypropyldinethoxy silane, vinyltrinethoxy silane, vinyltriethoxy silane, vinyltri(2-methoxyethoxy)silane, vinyltrisisopropoxy silane, vinlytris(tert-butylperoxy)silane, vinyldimethyethoxy silane, vintlynethyldinmethoxy silane, vinyl rnethyldiethoxy silane, aminophenyltrimethoxy silane, aminophenyltriethoxy silane, aminodiphenyldirnethoxy silane, aminodiphenyldiethoxy silane, amino(nithyldiphenylethoxy)silane, amnno(methyl phenyl diethoxy)silane, p-aminophenyltrimethoxy silane, p-aminophenyltriethoxy silane, p-aminophenylphenyldimethoxy silane, p-aminophenylphenyldiethoxy silane, methyl p-aminophenylphenylethoxy silane, p-aminophenylimethyldiethoxy silane, m-aminophenyltrimethoxy silane, m-aminophenyltriethoxy silane, ma-aminophenylphenyldinethoxy silane, m-aminophenylphenyldiethoxy silane, methyl m-aminophenylphenylethoxy silane, m-aminophenylmethyldiethoxy silane, o-aminophenyltri-nethoxy silane, o-aminophenyltriethoxy silane, o-aminophenylphenyldimethoxy silane, o-aminophenylphenyldiethoxy silane, methyl o-aminophenylphenylethoxy silane, o-amninophenylmethyldiethoxy silane, p-, m-, or o-amino benzene trimethoxy silane, p-, in-, or o-amino benzene trichloro silane, p-, or o-thio benzene trimethoxy silane, p-, m-, or o-thio benzene trichloro silane, and 1-thio 2, trimethoxy silyl ethane.

In another embodiment, the functional entity (FE or FG-L) is phosphorous-containing entity having the general chemical formula (Formula VI):

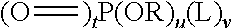

wherein the RO is a hydrolysable alkyloxy group as described above for the silane of Formula V, L of Formula VI is the same as described above for L in Formulas IV and V, “t” can have a value of zero or one, “u” can equal zero, one, or two, and “v” can equal one or two. In other words, the phosphorous-containing entity can be a phosphate, phosphonate, phosphinate, phosphonite, phosphinite, phosphine, or mixture thereof. While not wanting to be bound by any theory, the hydrolysable group RO of the reactive functional group FG reacts with one of the oxygens of the lacunary HPA, or salt thereof, to form a covalent bond generally comprising at least in part, —P—O—, linking the reactive functional group FG and HPA portions of the covalently bonded HPA, or salt thereof. While not wanting to be bound by any theory, the hydrolysable group of the reactive functional group FG reacts with one of the oxygens of the lacunary HPA, or salt thereof, to form a covalent bond generally comprising at least in part of an —O— linkage between the functional group FG and covalently bonded HPA, or salt thereof.

The resultant fluorinated ionomer may be referred to herein as a heteropolyacid-functionalized fluorinated ionomer (which also includes salts thereof). In certain embodiments, the fluorinated ionomer (i.e., heteropolyacid-functionalized fluorinated ionomer) includes a moiety having the following structure (Formula VII):

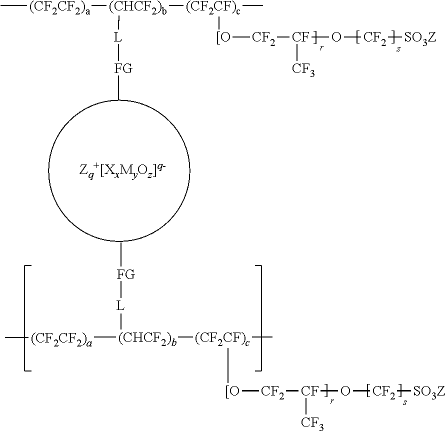

wherein “n” is 0, 1, 2, or 3. Preferably, n equals 0 or 1. Thus, the heteropolyacid group, or salt thereof (represented by the circle), can be covalently bonded to one or more precursor polymers through one or more functional entities (FG-L), wherein FG is a reactive functional group and L is a linking group, as described above.

In Formula VII, the fluorinated polymer backbone comprises —CF₂—CH— monomeric units (the “b” units) with pendent groups, tetrafluoroethylene monomeric units (—CF₂—CF₂—) (the “a” units), and trifluoroethylene monomeric units (—CF₂—CF—) (the “c” units) with pendent groups. These monomeric units are randomly distributed throughout the backbone of the polymer. In Formula VII: a is 0 to 80; b is 1 to 60; c is 10 to 40; r is 0 or 1; s is 1 to 4; each Z is independently selected from the group of H, Na, K, Li, Ca, Mn, Ce, ammonium, and substituted ammonium (e.g., tetramethyl ammonium); each X is independently a non-metal heteroatom; each M is independently a transition metal; O is oxygen; q is 2 to 30; x is 1 to 3; y is 5 to 25; and z is 20 to 130.

In certain embodiments, the pendent heteropolyacid groups, or salts thereof, are covalently bound to the fluorinated polymer backbone, preferably to —CF₂—CH— monomeric units, through a phosphorus-containing functional entity having the general chemical formula (Formula VIII):

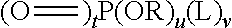

as described above (Formula VI). In certain embodiments, the phosphorus-containing functional entity is selected from the group of a phosphate, phosphonate, phosphinate, phosphonite, phosphine, and combinations thereof. In certain embodiments, the heteropolyacid groups are covalently bound to the fluorinated polymer backbone through an oxyphenyl phosphonate group.

In certain embodiments, the fluorinated ionomer includes a moiety having the following structure (Formula IX):

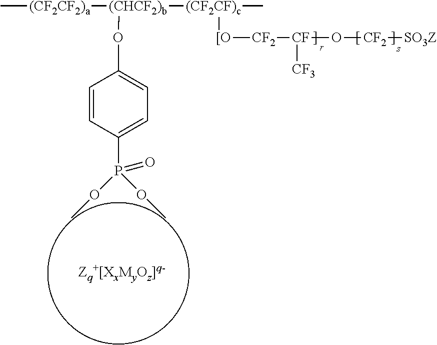

wherein: a is 0 to 80; b is 1 to 60; c is 10 to 40; r is 0 or 1; s is 1 to 4; each Z is independently selected from the group of H, Na, K, Li, Ca, Mn, Ce, ammonium, and substituted ammonium (e.g., tetramethyl ammonium); each X is independently a non-metal heteroatom; each M is independently a transition metal; O is oxygen; q is 2 to 30; x is 1 to 3, y is 5 to 25, and z is 20 to 130.

Although such repeat units of Formulas VII and IX are typically the same, they do not need to be. For example, one could use both the 3M monomer CF₂═CF—OC₄F₈SO₂F or the ‘Nafion monomer’ CF₂═CF—OCF₂CF(CF₃)OC₂F₄SO₂F in the same polymer. In other words, repeat units wherein r=0 and s=4 can be mixed with repeat units wherein r=1 and s=2

In certain embodiments of Formulas VII and IX, a is 40 to 80. In certain embodiments of Formulas VII and IX, a is 59 to 76.

In certain embodiments of Formulas VII and IX, b is 1 to 30. In certain embodiments of Formulas VII and IX, b is 5 to 15.

In certain embodiments of Formulas VII and IX, c is 15 to 25.

In certain embodiments of Formulas VII and IX, a+b+c is 100.

In certain embodiments of Formulas VII and IX, r is 1. In certain embodiments of Formulas VII and IX, r is 0.

In certain embodiments of Formulas VII and IX, s is 4.

In certain embodiments of Formulas VII and IX, each M is independently selected from the group of tungsten, molybdenum, vanadium, tantalum, niobium, manganese, and cerium.

In certain embodiments of Formulas VII and IX, each X is independently selected from the group of Groups 13 (Boron group), 14 (Carbon group), 15 (Nitrogen group), 16 (Oxygen group) of the Periodic Table. In certain embodiments of Formulas VII and IX, each X is independently selected from the group of silicon, phosphorus, and arsenic.

In certain embodiments of Formulas VII and IX, each Z is independently selected from the group of H, Na, K, and Li.

In certain embodiments, the fluorinated ionomer includes a unit having the following structure (Formula X):

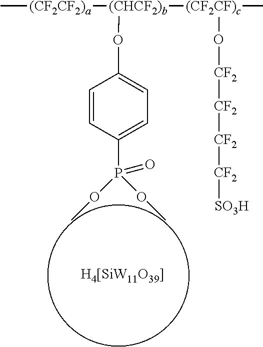

wherein: a is 25 to 80; b is 1 to 45; c is 10 to 30. In certain embodiments of Formula X, a is 59 to 76. In certain embodiments of Formula X, b is 5 to 15. In certain embodiments of Formula X, c is 15 to 25.

In certain embodiments, the fluorinated ionomer described herein has a weight average molecular weight of at least 50,000 grams/mole. In certain embodiments, the fluorinated ionomer has a weight average molecular weight of at least 100,000 grams/mole. There is no limit on the maximum molecular weight. The procedure for determining the weight average molecular weight is based on melt flow index measurements (MFI) as described in ASTM D 1238. Molecular weights are estimated from the relationship of (MFI)⁻¹=K*MW^{˜3.5} where K is an empirically derived constant.

### Methods of Making Polymer Ionomers

Methods of the present disclosure include a method of making the fluorinated ionomer described herein. The method includes: providing a precursor polymer comprising vinylidene fluoride monomeric units, tetrafluoroethylene monomeric units, and trifluoroethylene monomeric units with pendent groups comprising covalently bound perfluorosulfonyl fluoride groups; hydrolyzing the perfluorosulfonyl fluoride groups to form covalently bound perfluorosulfonate salt groups; optionally ion exchanging the perfluorosulfonate groups to form perfluorosulfonic acid groups; attaching a functional entity (FG-L) to the precursor polymer; and attaching a lacunary heteropolyacid, or salt thereof, to the functional entity to form covalently bound heteropolyacid groups, or salts thereof.

In one embodiment, hydrolyzing the perfluorosulfonyl fluoride groups occurs at the same time as attaching the functional entity (FG-L). The heteropolyacid, or salt thereof, is subsequently covalently bound to the functional entity, as shown in Scheme I.

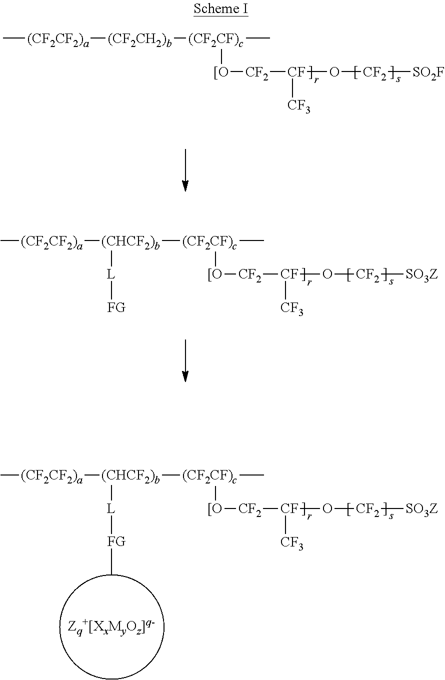

Alternatively, hydrolyzing the perfluorosulfonyl fluoride groups occurs before attaching the functional entity. The heteropolyacid, or salt thereof, is subsequently covalently bound to the functional entity, as shown in Scheme II.

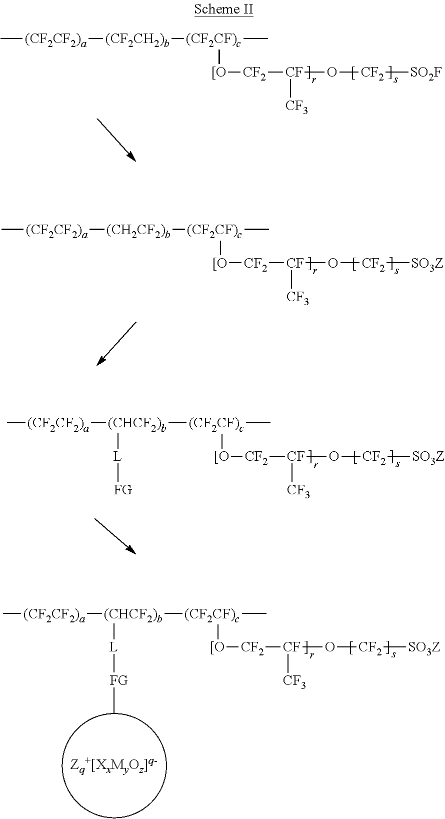

The steps of hydrolyzing and acidifying use standard reagents and conditions that are well-known to those of skill in the art, as demonstrated in the Examples Section. The step of attaching a lacunary heteropolyacid, or salt thereof, using a functional entity (FG-L) as described above uses standard reagents and conditions that are well-known to those of skill in the art, as demonstrated in the Examples Section.

### Articles

The articles of the present disclosure include a polymer electrolyte membrane (particularly, cation exchange membrane such as proton exchange membrane (PEM)), that includes the fluorinated ionomer as described herein, as well as a fuel cell that includes the polymer electrolyte membrane.

In some embodiments, the ionomer of the present disclosure may be useful for making a polymer electrolyte membrane using any suitable method. Typically, a membrane is cast from a fluoropolymer dispersion and then dried, annealed, or both. The ionomer may be cast from a suspension. Any suitable casting method may be used, including bar coating, spray coating, slit coating, and brush coating. After forming, the membrane may be annealed, typically at a temperature of 120° C. or higher, more typically 130° C. or higher, most typically 150° C. or higher. Typically, if the fluoropolymer dispersion is to be used to form a membrane, the concentration of ionomer is advantageously high (e.g., at least 20, 30, or 40 percent by weight). Often a water-miscible organic solvent is added to facilitate film formation. Examples of water-miscible solvents include lower alcohols (e.g., methanol, ethanol, isopropanol, n-propanol), polyols (e.g., ethylene glycol, propylene glycol, glycerol), ethers (e.g., tetrahydrofuran and dioxane), ether acetates, acetonitrile, acetone, dimethylsulfoxide (DMSO), N,N-dimethylacetamide (DMA), ethylene carbonate, propylene carbonate, dimethylcarbonate, diethylcarbonate, N,N-dimethylformamide (DMF), N-methylpyrrolidinone (NMP), dimethylimidazolidinone, butyrolactone, hexamethylphosphoric triamide (HMPT), isobutyl methyl ketone, sulfolane, and combinations thereof.

In certain preferred embodiments, the ionomer of the present disclosure may be useful as a PEM and/or useful for making a membrane or catalyst ink composition. In some embodiments, the ionomer described herein can be fabricated into membranes using common methods such as solvent casting as described in U.S. Pat. No. 7,348,088 (Hamrock et al.). The ionomer is converted into a suspension or solution for casting. Any suitable carrier or solvent may be used, typically including water. The membrane is cast onto a liner or carrier or other surface by any suitable method including bar coating, spray coating, slit coating, transfer roll coating, and the like. The casting is typically dried followed by a higher temperature annealing step. The cast film is removed from the casting surface prior to use.

In some embodiments, the membranes can be fabricated to include a mechanical reinforcement such as expanded poly(tetrafluoroethylene) (ePTFE) as described in U.S. Pat. No. 5,599,614 (Bahar et al.). Alternatively, an electrospun nanofiber may be used, as described in U.S. Pat. Pub. No. 2013/0101918 (Yandrasits et al.).

In certain embodiments, the ionomer (e.g., as a component of the fluoropolymer dispersion) can be combined with catalyst particles (e.g., metal particles or carbon-supported metal particles). A variety of catalysts may be useful. Typically, carbon-supported catalyst particles are used. Typical carbon-supported catalyst particles are 30% to 95% carbon and 5% to 70% catalyst metal by weight, the catalyst metal typically comprising platinum for the cathode and platinum or platinum and ruthenium in a weight ratio of 2:1 for the anode. However, other metals may be useful, for example, gold, silver, palladium, iridium, rhodium, iron, cobalt, nickel, chromium, tungsten, manganese, vanadium, and alloys thereof. To make a membrane electrode assembly (MEA) or catalyst coated membrane (CCM), catalyst may be applied to the PEM by any suitable means, including both hand and machine methods, including hand brushing, notch bar coating, fluid bearing die coating, wire-wound rod coating, slot-fed knife coating, three-roll coating, or decal transfer. Coating may be achieved in one application or in multiple applications. Advantageously, ionomers according to the present disclosure may be useful for making a catalyst layer with one coating application. The catalyst ink may be applied to a PEM or a gas diffusion layer (GDL) directly, or the catalyst ink may be applied to a transfer substrate, dried, and thereafter applied to the PEM or to the GDL as a decal.

In some embodiments, the catalyst ink includes the ionomer disclosed herein at a concentration of at least 10, 15, or 20 percent by weight and up to 30 percent by weight, based on the total weight of the catalyst ink. In some embodiments, the catalyst ink includes the catalyst particles in an amount of at least 10, 15, or 20 percent by weight and up to 50, 40, or 30 percent by weight, based on the total weight of the catalyst ink. The catalyst particles may be added to the fluoropolymer dispersion made as described above in any of its embodiments. The resulting catalyst ink may be mixed, for example, with heating. The percent solids in the catalyst ink may be selected, for example, to obtain desirable rheological properties. Examples of suitable organic solvents useful for including in the catalyst ink include lower alcohols (e.g., methanol, ethanol, isopropanol, n-propanol), polyols (e.g., ethylene glycol, propylene glycol, glycerol), ethers (e.g., tetrahydrofuran and dioxane), diglyme, polyglycol ethers, ether acetates, acetonitrile, acetone, dimethylsulfoxide (DMSO), N,N dimethylacetamide (DMA), ethylene carbonate, propylene carbonate, dimethylcarbonate, diethylcarbonate, N,N-dimethylformamide (DMF), N-methylpyrrolidinone (NMP), dimethylimidazolidinone, butyrolactone, hexamethylphosphoric triamide (HMPT), isobutyl methyl ketone, sulfolane, and combinations thereof. In some embodiments, the catalyst ink contains 0% to 50% by weight of a lower alcohol and 0% to 20% by weight of a polyol. In addition, the ink may contain 0% to 2% of a suitable dispersant.

In some embodiments of the polymer electrolyte membrane of the present disclosure, a salt of at least one of cerium, manganese, or ruthenium, or one or more cerium oxide or zirconium oxide compounds is added to the acid form of the ionomer before membrane formation. Typically, the salt of cerium, manganese, or ruthenium, and/or the cerium or zirconium oxide compound is mixed well with or dissolved within the ionomer to achieve substantially uniform distribution.

The salt of cerium, manganese, or ruthenium may comprise any suitable anion, including chloride, bromide, hydroxide, nitrate, sulfonate, acetate, phosphate, and carbonate. More than one anion may be present. Other salts may be present, including salts that include other metal cations, ammonium, or substituted ammonium (e.g., tetramethyl ammonium) cations. Once cation exchange occurs between the transition metal salt and the acid form of the ionomer, it may be desirable for the acid formed by combination of the liberated proton and the original salt anion to be removed. Thus, it may be useful to use anions that generate volatile or soluble acids, for example chloride or nitrate. Manganese cations may be in any suitable oxidation state, including Mn²⁺, Mn³⁺, and Mn⁴⁺, but are most typically Mn²⁺. Ruthenium cations may be in any suitable oxidation state, including Ru³⁺ and Ru⁴⁺, but are most typically Ru³⁺. Cerium cations may be in any suitable oxidation state, including Ce³⁺ and Ce⁴⁺. Without wishing to be bound by theory, it is believed that the cerium, manganese, or ruthenium cations persist in the polymer electrolyte because they are exchanged with H+ ions from the anion groups of the polymer electrolyte and become associated with those anion groups. Furthermore, it is believed that polyvalent cerium, manganese, or ruthenium cations may form ionic crosslinks between anion groups of the polymer electrolyte, further adding to the stability of the polymer. In some embodiments, the salt may be present in solid form. The cations may be present in a combination of two or more forms including solvated cation, cation associated with bound anion groups of the polymer electrolyte membrane, and cation bound in a salt precipitate. The amount of salt added is typically between 0.001 and 0.5 charge equivalents based on the molar amount of acid functional groups present in the polymer electrolyte, more typically between 0.005 and 0.2, more typically between 0.01 and 0.1, and more typically between 0.02 and 0.05. Further details for combining an anionic copolymer with cerium, manganese, or ruthenium cations can be found in U.S. Pat. No. 7,575,534 (Frey et al.) and U.S. Pat. No. 8,628,871 (Frey et al.).

Membrane thickness can range from 5 to 500 micrometers in thickness. The polymer electrolyte membrane, in some embodiments, may have a thickness of up to 90 micrometers, up to 60 micrometers, up to 30 micrometers, or up to 20 micrometers. A thinner membrane may provide less resistance to the passage of ions. In fuel cell use, this results in cooler operation and greater output of usable energy.

In some embodiments, the heteropolyacid-functionalized fluorinated ionomer of the present disclosure may be blended, e.g., in an amount of 5-50 wt-%, with a non-heteropolyacid-functionalized fluorinated ionomer. Such blend may be formed into a membrane.

In some embodiments, the heteropolyacid-functionalized fluorinated ionomer of the present disclosure may be imbibed into a porous supporting matrix, typically in the form of a thin membrane having a thickness of up to 90 micrometers, up to 60 micrometers, up to 30 micrometers, or up to 20 micrometers. Any suitable method of imbibing the ionomer into the pores of the supporting matrix may be used, including overpressure, vacuum, wicking, and immersion. Any suitable supporting matrix may be used. Typically, the supporting matrix is electrically non-conductive. Typically, the supporting matrix is composed of a fluoropolymer, which is more typically perfluorinated. Typical matrices include porous polytetrafluoroethylene (PTFE), such as biaxially stretched PTFE webs. In another embodiment fillers (e.g., fibers) might be added to the polymer to reinforce the membrane.

To make an MEA, GDL's may be applied to either side of a CCM by any suitable means. Any suitable GDL may be used in the practice of the present disclosure. Typically, the GDL is comprised of sheet material comprising carbon fibers. Typically, the GDL is a carbon fiber construction selected from woven and non-woven carbon fiber constructions. Carbon fiber constructions which may be useful in the practice of the present disclosure may include TORAY Carbon Paper, SPECTRACARB Carbon Paper, AFN™ non-woven carbon cloth, and ZOLTEK Carbon Cloth. The GDL may be coated or impregnated with various materials, including carbon particle coatings, hydrophilizing treatments, and hydrophobizing treatments such as coating with polytetrafluoroethylene (PTFE).

In use, the MEA according to the present disclosure is typically sandwiched between two rigid plates, known as distribution plates, also known as bipolar plates (BPP's) or monopolar plates. Like the GDL, the distribution plate is typically electrically conductive. The distribution plate is typically made of a carbon composite, metal, or plated metal material. The distribution plate distributes reactant or product fluids to and from the MEA electrode surfaces, typically through one or more fluid-conducting channels engraved, milled, molded or stamped in the surface(s) facing the MEA(s). These channels are sometimes designated a flow field. The distribution plate may distribute fluids to and from two consecutive MEA's in a stack, with one face directing fuel to the anode of the first MEA while the other face directs oxidant to the cathode of the next MEA (and removes product water), hence the term “bipolar plate.” Alternately, the distribution plate may have channels on one side only, to distribute fluids to or from an MEA on only that side, which plate may be termed a “monopolar plate.” A typical fuel cell stack comprises a number of MEA's stacked alternately with bipolar plates.

### Exemplary Embodiments

Embodiment 1 is a fluorinated ionomer (i.e., ion conducting polymer) comprising a fluorinated polymer backbone and pendent groups comprising: covalently bound heteropolyacid groups, or salts thereof, and covalently bound perfluorosulfonic acid groups, or salts thereof; wherein the perfluorosulfonic acid groups are present in an amount of at least 40 mol % of the total amount of pendent groups.

Embodiment 2 is the fluorinated ionomer of embodiment 1 wherein the pendent groups comprise: 10-39 mol % covalently bound heteropolyacid groups, or salts thereof, and 61-90 mol % covalently bound perfluorosulfonic acid groups, or salts thereof, wherein the percentages are based on the total amount of pendent groups.

Embodiment 3 is the fluorinated ionomer of embodiment 1 or 2 wherein the pendent heteropolyacid groups, or salts thereof, are derived from a heteropolyacid, or salt thereof, having the following general structure (Formula II):

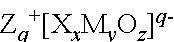

wherein: each Z is independently selected from the group of H, Na, K, Li, Ca, Mn, Ce, ammonium, and substituted ammonium (e.g., tetramethyl ammonium); each X is independently a non-metal heteroatom; each M is independently a transition metal; O is oxygen; q is 2 to 30; x is 1 to 3; y is 5 to 25; and z is 20 to 130.

Embodiment 4 is the fluorinated ionomer of embodiment 3 wherein the pendent heteropolyacid groups, or salts thereof, are derived from a heteropolyacid having a lacunary structure.

Embodiment 5 is the fluorinated ionomer of any of the previous embodiments wherein pendent sulfonic acid groups, or salts thereof, have the structure (Formula III) —[O—CF₂—CF(CF₃)]ᵣ—O—[CF₂]ₛ—SO₃Z wherein “r” is 0 or 1, and “s” is 1 to 4, and Z is selected from the group of H, Na, K, Li, Ca, Mn, Ce, ammonium, and substituted ammonium (e.g., tetramethyl ammonium).

Embodiment 6 is the fluorinated ionomer of any of the previous embodiments wherein the pendent heteropolyacid groups, or salts thereof, are covalently bound to the fluorinated polymer backbone through a functional entity.

Embodiment 7 is the fluorinated ionomer of embodiment 6 wherein the pendent heteropolyacid groups are covalently bound to the fluorinated polymer backbone through a phosphorus-containing functional entity.

Embodiment 8 is the fluorinated ionomer of embodiment 7 wherein the phosphorus-containing functional entity is selected from the group of a phosphate, phosphonate, phosphinate, phosphonite, phosphine, and combinations thereof.

Embodiment 9 is the fluorinated ionomer of embodiment 8 wherein the heteropolyacid groups are covalently bound to the fluorinated polymer backbone through an oxyphenyl phosphonate group.

Embodiment 10 is the fluorinated ionomer of any of the previous embodiments wherein the fluorinated polymer backbone comprises —CF₂—CH— monomeric units (with pendent groups), trifluoroethylene monomeric units (with pendent groups), and tetrafluoroethylene monomeric units.

Embodiment 11 is the fluorinated ionomer of embodiment 10 wherein the pendent heteropolyacid groups are covalently bound to —CF₂—CH— monomeric units through a phosphorus-containing functional entity.

Embodiment 12 is the fluorinated ionomer of embodiment 11 comprising a moiety having the structure (Formula VII):

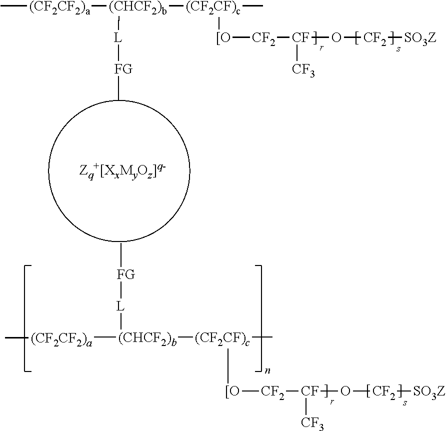

wherein: n is 0, 1, 2, or 3 (preferably, n equals 0 or 1);
FG is a reactive functional group;
L is a linking group;
a is 0 to 80;
b is 1 to 60;
cis 10 to 40;
r is 0 or 1;
s is 1 to 4;
each Z is independently selected from the group of H, Na, K, Li, Ca, Mn, Ce, ammonium, and substituted ammonium (e.g., tetramethyl ammonium);
each X is independently a non-metal heteroatom;
each M is independently a transition metal;
q is 2 to 30;
x is 1 to 3;
y is 5 to 25; and
z is 20 to 130.

Embodiment 13 is the fluorinated ionomer of embodiment 12 wherein the moiety has the following structure (Formula IX):

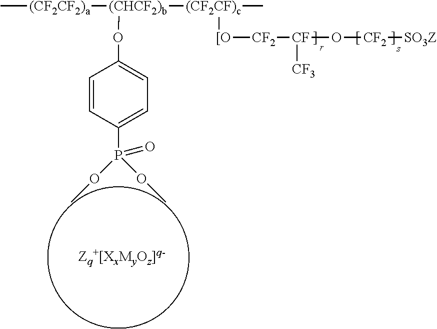

wherein: a is 0 to 80;
b is 1 to 60;
c is 10 to 40;
r is 0 or 1;
s is 1 to 4;
each Z is independently selected from the group of H, Na, K, Li, Ca, Mn, Ce, ammonium, and substituted ammonium (e.g., tetramethyl ammonium);
each X is independently a non-metal heteroatom;
each M is independently a transition metal;
q is 2 to 30;
x is 1 to 3;
y is 5 to 25; and
z is 20 to 130.

Embodiment 14 is the fluorinated ionomer of embodiment 12 or 13 wherein a is 40 to 80 or 59 to 76.

Embodiment 15 is the fluorinated ionomer of any of embodiments 12 through 14 wherein b is 1 to 30 or 5 to 15.

Embodiment 16 is the fluorinated ionomer of any of embodiments 12 through 15 wherein c is 15 to 25.

Embodiment 17 is the fluorinated ionomer of any of embodiments 12 through 16 wherein r is 1.

Embodiment 18 is the fluorinated ionomer of any of embodiments 12 through 16 wherein r is 0.

Embodiment 19 is the fluorinated ionomer of any of embodiments 12 through 18 wherein s is 4.

Embodiment 20 is the fluorinated ionomer of any of embodiments 12 through 19 wherein each M is independently selected from the group of tungsten, molybdenum, vanadium, tantalum, niobium, manganese, and cerium.

Embodiment 21 is the fluorinated ionomer of any of embodiments 12 through 20 wherein each X is independently selected from the group of Groups 13 (Boron group), 14 (Carbon group), 15 (Nitrogen group), 16 (Oxygen group) of the Periodic Table. In certain embodiments, each X is independently selected from the group of silicon, phosphorus, and arsenic.

Embodiment 22 is the fluorinated ionomer of any of embodiments 12 through 19 wherein each Z is independently selected from the group of H, Na, K, and Li.

Embodiment 23 is the fluorinated ionomer of any of embodiments 12 through 22 wherein the moiety has the following structure (Formula X):

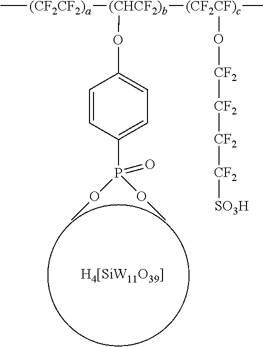

wherein a is 25 to 80, b is 1 to 45, and c is 10 to 30.

Embodiment 24 is the fluorinated ionomer of embodiment 23 wherein a is 59 to 76, b is 5 to 15, and c is 15 to 25.

Embodiment 25 is the fluorinated ionomer of any of the previous embodiments having a weight average molecular weight of at least 50,000 grams/mole.

Embodiment 26 is the fluorinated ionomer of embodiment 25 having a weight average molecular weight of at least 100,000 grams/mole.

Embodiment 27 is a fluoropolymer dispersion comprising the fluorinated ionomer of any of embodiments 1 through 26.

Embodiment 28 is a polymer electrolyte membrane comprising the fluorinated ionomer of any of embodiments 1 through 26.

Embodiment 29 is the polymer electrolyte membrane of embodiment 28 having a thickness of 5 to 500 micrometers in thickness.

Embodiment 30 is the polymer electrolyte membrane of embodiment 28 or 29 having a thickness of up to 90 micrometers, up to 60 micrometers, up to 30 micrometers, or up to 20 micrometers.

Embodiment 31 is the polymer electrolyte membrane of any of embodiments 28 through 30 wherein the fluorinated ionomer is imbibed into a porous supporting matrix.

Embodiment 32 is the polymer electrolyte membrane of embodiment 31 wherein the porous supporting matrix is electrically non-conductive.

Embodiment 33 is the polymer electrolyte membrane of embodiment 32 wherein the porous supporting matrix comprises a fluoropolymer.

Embodiment 34 is the polymer electrolyte membrane of embodiment 33 wherein the porous supporting matrix comprises a perfluorinated fluoropolymer.

Embodiment 35 is the polymer electrolyte membrane of any of embodiments 28 through 30 wherein the heteropolyacid-functionalized fluorinated ionomer (e.g., 5-50 wt-%) is blended with a non-heteropolyacid-functionalized fluorinated ionomer.

Embodiment 36 is a fuel cell comprising the polymer electrolyte membrane of any one of embodiments 28 through 35.

Embodiment 37 is a method of making the fluorinated ionomer of any of embodiments 1 through 26, the method comprising: providing a precursor polymer comprising vinylidene fluoride monomeric units, tetrafluoroethylene monomeric units, and trifluoroethylene monomeric units with pendent groups comprising covalently bound perfluorosulfonyl fluoride groups; hydrolyzing the perfluorosulfonyl fluoride groups to form covalently bound perfluorosulfonate salt groups; optionally ion exchanging the perfluorosulfonate groups to form perfluorosulfonic acid groups; attaching a functional entity (FG-L) to the precursor polymer; and attaching a lacunary heteropolyacid, or salt thereof, to form covalently bound heteropolyacid groups, or salts thereof to the functional entity.

Embodiment 38 is the method of embodiment 37 wherein hydrolyzing the perfluorosulfonyl fluoride groups occurs at the same time as attaching the functional entity (FG-L), and the heteropolyacid, or salt thereof, is subsequently covalently bound to the functional entity, as shown in Scheme I.

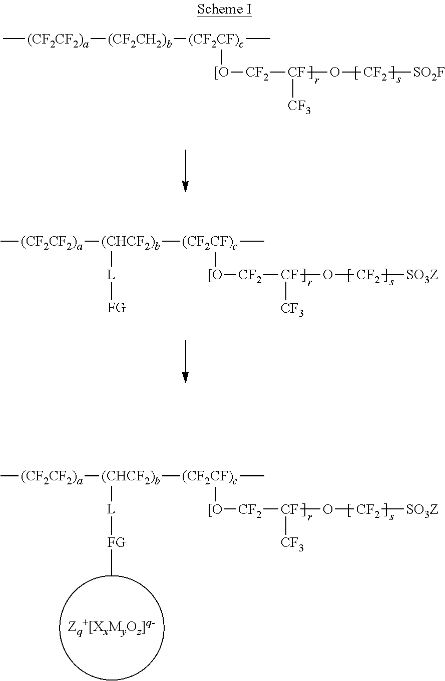

Embodiment 39 is the method of embodiment 37 wherein hydrolyzing the perfluorosulfonyl fluoride groups occurs before attaching the functional entity, and the heteropolyacid, or salt thereof, is subsequently covalently bound to the functional entity, as shown in Scheme II:

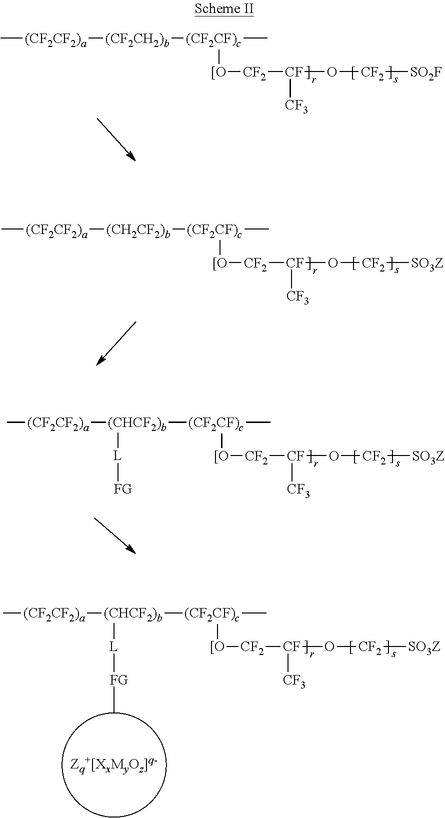

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Unless otherwise noted, all parts, percentages, ratios, etc. in the examples and the rest of the specification are by weight, and all reagents used in the examples were obtained, or are available, from general chemical suppliers, or may be synthesized by conventional methods.

Materials Used in the Examples

| Abbreviation | Linear Formula | MW (g/mol) |
|---|---|---|
| TFE | (CF₂—CF₂) | 100.02 |
| MV4S | [CF₂—CF—(OC₄F₈SO₂F)] | 380.11 |
| VDF | (CF₂—CH₂) | 64.03 |
| DHPP | (OH)(C₆H₄)(P═O)(OC₂H₅)₂ | 230.2 |
| DHPPA | (OH)(C₆H₄)(P═O)(OH)₂ | 174.2 |
| HPA | K₈SiW₁₁O₃₉•13H₂O | 3225.43 |
| BTMS | (CH₃)₃SiBr | 153.09 |

| Abbreviation | Description and Source |
|---|---|
| PE-1 | 3M ionomer with TFE-MV4S-VDF random polymer |
| | Molecular percentages of each polymer block are 67 mole percent (mol %) |
| | TFE, 15 mol % MV4S, and 18 mol % VDF. |
| PE-2 | 3M ionomer with TFE-MV4S-VDF random polymer |
| | Molecular percentages of each polymer block are 76.2 mol % TFE, 18.5 mol % |
| | MV4S, and 5.3 mol % VDF. |
| PE-3 | 3M ionomer with TFE-MV4S-VDF random polymer |
| | Molecular percentages of each polymer block are 70.2 mol % TFE, 18.8 mol % |
| | MV4S, and 11 mol % VDF. |
| PE-4 | 3M ionomer with TFE-MV4S-VDF random polymer |
| | Molecular percentages of each polymer block are 64.6 mol % TFE, 18.2 mol % |
| | MV4S, and 17.2 mol % VDF. |
| PE-5 | 3M ionomer with TFE-MV4S-VDF random polymer |
| | Molecular percentages of each polymer block are 58.7 mol % TFE, 18.2 mol % |
| | MV4S, and 23.1 mol % VDF. |
| DHPP | Diethyl(4-hydroxyphenyl)phosphonate), SynQuest Labs, Alachua, FL. |
| BTMS | Bromotrimethylsilane, 97%, Sigma Aldrich, St. Louis, MO. |
| NaOH | Sodium hydroxide, 98%, Aldrich |
| KOH | Potassium hydroxide solution in methanol, 1N, Aldrich |
| HCl | Hydrochloric acid, Macron Fine Chemicals, 36.5% -38%, obtained from |
| | VWR Arlington Heights, IL |
| H₂SO₄ | Sulfuric acid, EMD Millipore, Burlington, MA |
| MeOH | Methanol, Pharmco, ACS grade, Brookfield, CT |
| i-PrOH | Iso-propanol, Pharmco, ACS grade, Brookfield, CT |
| CH₃CN | Acetonitrile, Acros Organics, 99.9%, anhydrous, Fair Lawn, NJ |
| DMAc | N,N-dimethylacetamide, Acros Organics, 99+%, anhydrous |
| HPA | Lacunary heteropoly acid, K₈SiW₁₁O₃₉, Colorado School of Mines, Golden, |
| | CO |

### Preparatory Example 1 (PE-1): TFE/VDF/MV4S Polymer

The sulfonyl fluoride containing monomer; F₂C═CF—O—CF₂CF₂CF₂CF₂SO₂F (designated MV4S) was prepared according to the method described in U.S. Pat. No. 6,624,328 (Guerra). A 4-L polymerization kettle equipped with an impeller agitator system was charged with ammonium oxalate monohydrate (5 grams (g)) and oxalic acid dihydrate (1 g) in H₂O (2000 g) and 40 g of a 30 weight percent (wt-% or w/w) aqueous solution of CF₃—O—(CF₂)₃—O—CFH—CF₂—COONH₄, prepared as described in “Preparation of Compound 11” in U.S. Pat. No. 7,671,112. The kettle was degassed and subsequently charged with nitrogen several times to assure that all of oxygen was removed.

Afterwards, the kettle was purged with TFE. The kettle was then heated to 50° C. and the agitation system was set to 320 rpm. A mixture of 193 g MV4S, 126 g deionized water and 6.5 g of a 30 wt-% solution of CF₃—O—(CF₂)₃—O—CFH—CF₂—COONH₄ were emulsified under high shear by an agitator available under the trade designation ULTRA-TURRAX agitator operated at 24000 revolutions per minute (rpm) for 3 minutes.

The MV4S emulsion was charged into the reaction kettle. The kettle was further charged with vinylidene fluoride monomer (VDF) (6 g) and 114 g of tetrafluoroethylene (TFE) to a pressure of 6 bar (600 kPa). The polymerization was initiated by a 0.02% solution of KMnO₄ (19 g) in deionized water. As the reaction started, the reaction temperature of 50° C. as well as the reaction pressure of 6 bar (600 kPa) were maintained by feeding TFE and VDF into the gas phase. After the first pressure drop, the continuous feeding of the MV4S emulsion (in total 887 g; 526 g MV4S and 18 g of the 30 wt-% solution of CF₃—O—(CF₂)₃—O—CFH—CF₂—COONH₄ in 343 g deionized water), TFE (551 g), VDF (69 g) and a solution of 0.02% KMnO₄ in deionized water (232 g) was continuously added.

The average metering rate of the continuous addition of the 0.02% KMnO₄ solution was 65 grams per hour (g/h) to obtain a polymer dispersion with a solid content of 31.5%. The polymerization time was 222 minutes (min). The coagulated and washed polymer had an MFI (265° C./5 kilograms (kg)) of 8.7 g/10 min. The so-obtained polymer showed a chemical composition of 67 mol % TFE, 15 mol % MV4S and 18 mol % VDF as obtained by solid state ¹⁹F-NMR-spectroscopy.

Preparatory Examples 2-5 (PE-2 through PE-5) were synthesized using the method of Preparatory Example 1 (PE-1). The ratio of monomers was varied as indicated in the following table. In calculating the mole percentages of the pendent HPA and perfluorosulfonic acid/salt groups, for an HPA group, or salt thereof, the number of protons or salts thereof included in any one HPA group can vary from 2-30 (value of “q”), however, the number of pendent HPA groups is used for the calculation of mole percentages.

| | | | | | Mole Percent of |
|---|---|---|---|---|---|
| | | | | | perflourosulfonic acid |
| | TFE | MV4S | VDF | EW | groups to total pendent |
| Example | (mol %) | (mol %) | (mol %) | (g/mol) | groups (mol %) |
| PE-1 | 67 | 15 | 18 | 903 | 45 |
| PE-2 | 76.2 | 18.5 | 5.3 | 810 | 78 |
| PE-3 | 70.2 | 18.8 | 11 | 791 | 63 |
| PE-4 | 64.6 | 18.2 | 17.2 | 795 | 51 |
| PE-5 | 58.7 | 18.2 | 23.1 | 784 | 44 |

### Comparative Preparatory Example 1 (CPE-1): Sulfonyl Fluoride Hydrolysis with Strong

### Base

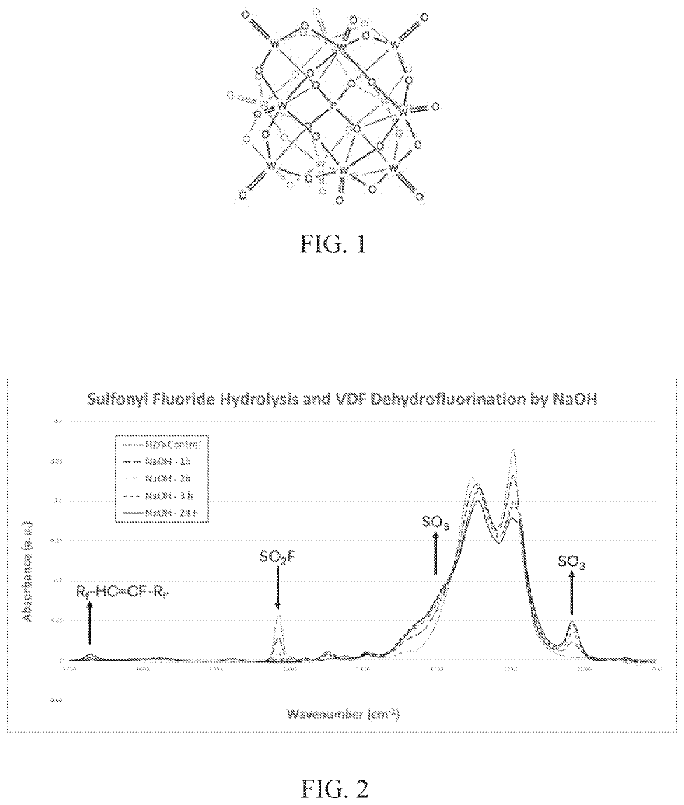

A film was hot pressed from several grams of PE-1 polymer between two sheets of 2 mil (0.05 millimeter (mm)) Kapton to form a film 240-370 micrometers thick. From the film were cut 8 strips approximately 1 centimeter (cm)×3 cm and each was placed into a separate 4 milliliter (mL) glass vial. The film strips were then each subjected to 4 mL 1.0M NaOH (aq) in 50/50 MeOH/H2O (w/w). The capped vials were placed in a 50° C. aluminum heating block (Techne DriBlock DB200/3) and reaction was run for 1, 2, 3, and 24 hours, removing one vial at each designated treatment time. Upon removal from the heating block, the reaction solution was decanted, and films were washed three times with 4 mL deionized water followed by a 4 mL 1.0M HCl(aq) soak overnight. The films were then washed with deionized (DI) H₂O until neutral pH was obtained and subjected to a 4 mL NaCl (aq) brine soak for 1-2 hours. If after 1 hour the pH was acidic, the film was washed with two 4 mL deionized water aliquots and subjected to another 1-hour brine soak and pH was measured again. This process was repeated until neutral pH after 1 hour was achieved. The film was finally washed with three 4 mL deionized water aliquots, blotted dry, and vacuum dried at 50° C. overnight. Samples were analyzed by ATR-IR to assess degree of hydrolysis and to observe extent of sulfonyl fluoride hydrolysis and main chain dehydrofluorination of VDF units. FIG. 2 shows the loss of the 1465 cm⁻¹ peak and the formation of the 1060 cm⁻¹ peak, indicating the sulfonyl fluoride is hydrolyzed to sodium sulfonate. The formation of a peak at 1720 cm⁻¹ shows dehydrofluorination to form the undesired —CF═CH— unit in the polymer backbone.

### Preparatory Example 6 (PE-6): Sulfonyl Fluoride Hydrolysis with Mild Base

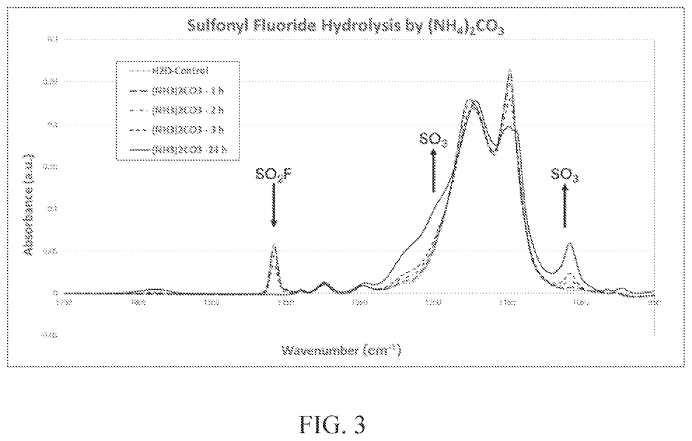

The process described in Comparative Preparatory Example 1 (CPE-1) was used with 0.5 Molar (M) ammonium carbonate instead of 1.0M NaOH. All other conditions and wash steps were the same. FIG. 3 shows the loss of the 1465 cm⁻¹ peak and the formation of the 1060 cm⁻¹ peak, indicating the sulfonyl fluoride is hydrolyzed to sulfonate. The absence of the peak at 1720 cm⁻¹ shows no detectable dehydrofluorination occurred in this sample.

### Preparatory Example 7 (PE-7)

Lacunary heteropoly acid (HPA, K₈SiW₁₁O₃₉) was synthesized using the method below: Sodium metasilicate (Na₂SiO₃, SiO₂; 44-47%, 11.82 g, 50 millimoles (mmol)) was dissolved in 100 mL of DI water at room temperature with magnetic stirring (if the solution was not completely clear, it needed to be filtered) (Solution A). In a 1-L beaker, sodium tungstate (Na₂WO₄. 2H₂O, 182 g, 0.55 mol) was dissolved in 300 mL of boiling water (Solution B) with magnetic stirring. To the boiling Solution B, an aqueous solution of 4M HCl (165 mL) was added dropwise in ca. 30 min, with vigorous stirring to dissolve the local precipitate of tungstic acid. Solution A was quickly added, then 50 mL of aqueous solution of 4M HCl was added, too. The pH was ca. 5 to 6. The reaction mixture was kept boiling for 1 hour. During the boiling, kept the pH ca. 5 to 6 by adding small amount of aqueous solution of 4M HCl. After cooling to room temperature, the reaction mixture was filtered on a filter funnel. Potassium chloride (150 g) was added to the clear filtrate with stirring at room temperature. The white solid product was collected on a fritted glass funnel (medium porosity), washed with cold 1M KCl solution (2×50 mL), then washed with ice-cold DI water (2×50 mL), and dried in air. Yield 140.5 g (87.1%).

### Material Synthesis

Identical methods to chemically immobilize HPA to TFE-MV4S-VDF ionomer were used but with different amount of HPAs and functionalization-related solvents. Functionalization of representative sample PE-1 will be used to describe the synthesis.

### Preparatory Example X-1 (PE:X-1): Diethyl (4-Hydroxyphenyl) Phosphonate (DHPP) Grafted onto PE-1

10.46 g of PE-1 (12.99 mmol) was suspended in DMAc (150 mL) at 45° C. 28.96 mmol of 0.1M NaOH in i-PrOH, was slowly added to the reaction mixture day by day.

Day 1: Added 0.1M NaOH in i-PrOH (100 mL, 10 mmol) to the polymer mixture and stirred at 45° C. overnight.

Day 2: Added more 0.1M NaOH in i-PrOH (40 mL, 4 mmol) to the yellow-orange mixture that contained white solid and stirred at 45° C. overnight.

Day 3: Orange cloudy mixture contained less white solid. 1.25 equivalent of DHPP (based on vinylidene fluoride content) in 1M KOH in MeOH was added to the polymer mixture. The reaction mixture was stirred at 45° C. for 2 hours. The yellow-orange mixture contained white solid. Next, 0.1M NaOH in i-PrOH (10 mL, 1 mmol) was added and stirred at 45° C. overnight. Total base used was 15 mmol.

Day 4: Orange clear reaction mixture was formed. The reaction mixture was precipitated in 1.2M HCl_{(aq)} (750 mL). The yellow solid was collected on the fritted funnel (coarse size), then rinsed with DI water until pH of about 6 on pH testing paper. The yellow solid was dried in air first and then dried under vacuum for 48 h at 40° C., producing phenol phosphonic ester functionalized PE-1 (PE-1/DHPP=PE:X-1). Yield: 88% (yellow solid) (MCK-12-53A). ³¹P NMR (162 MHz, DMSO-d₆): δ=16.2 (s) ppm.

### Preparatory Example XY-1 (PE:XY-1): Hydrolysis of Phosphonate was Conducted to Covalently Attach HPA to PE:X-1

PE:X-1 (PE-1/DHPP) (9.2 g) was suspended in dry acetonitrile (200 mL) under ultrahigh purity nitrogen at room temperature. Then the polymer mixture was cooled to 0° C. Bromotrimethylsilane (10 mL, 11.24 g, 73.5 mmol) was added to the reaction mixture under N_{2(g)} at room temperature. The reaction was heated gradually to 50° C. and allowed to react for 22 hours under stirring without N_{2(g)} purging. The reaction mixture was cooled down to room temperature, then quenched in methanol (300 mL) contained 10 vol % of conc. HCl. The reaction mixture was stirred at room temperature for 3 hours. The polymer mixture was decanted, and the pale-yellow gel was isolated, dried in air, washed with water until about 6 on pH testing paper, dried in air first, and dried under vacuum for 48 hours. Yield: 91% (pale yellow solid) (MCK-12-58A). ³¹P NMR (162 MHz, DMSO-d₆): δ=11.5 (s) ppm.

### Example 1 (EX-1): Covalent Attachment of Lacunary HPA to Starting Material PE: XY-1

Material from Preparatory Example PE: XY-1 (PE-1/DHPPA) (5.06 g) was suspended in DMAc (100 mL) at room temperature overnight. HPA (K₈SiW₁₁O₃₉, 3.65 g, 1.131 mmol, 1 equiv.) was added to the homogeneous polymer solution at room temperature. The cloudy mixture was stirred at room temperature for 5 minutes. Concentrated HCl (12M, 0.565 mL, 6 equiv.) was added dropwise to the reaction mixture at room temperature. Then the reaction mixture was stirred at 80° C. for 3 days. The samples then went through KCl removal and acid-exchange. To remove the unwanted KCl crystals, the solution was centrifuged for 20 minutes at 4,500 RPM and decanted from the KCl solids. The non-precipitated solution was used to either blend with 3M PFSA or casted by itself. After the casting of membrane, it was acid-exchanged by washing with 4M sulfuric acid at room temperature followed by multiple DI water rinses. The polymer mixture without filtration was drop-casted on a TEFLON plate and evaporated in air for 2 days.

### Preparatory Examples X-2 Through X-4 and Prophetic Example X-5

Additional preparatory examples were made using the methods described in preparatory example PE: X-1. The amount of base and DHPP were changed based on the vinylidene fluoride content of the precursor polymer.

| Example | | VDF | Polymer | 0.1M NaOH | DHPP |
|---|---|---|---|---|---|
| (PE: X-#) | Polymer | (mol %) | (g) | (mL) | (g) |
| PE: X-1 | PE-1 | 18 | 10.5 | 80 | 2.302 |
| PE: X-2 | PE-2 | 5.4 | 5.3 | 33.76 | 0.525 |
| PE: X-3 | PE-3 | 11.1 | 5.3 | 42.61 | 1.092 |
| PE: X-4 | PE-4 | 17.2 | 10 | 90 | 3.03 |
| PE: X-5* | PE-5 | 23.1 | 10.53 | 76 | 4.31 |

### Preparatory Examples XY-2 Through XY-4 and Prophetic Example XY-5

Hydrolysis of the DHPP was completed following the methods of PE: XY-1 using the tabulated quantities below.

| | PE: X-#: | Precursor | BTMS | Methanol | Yield |
|---|---|---|---|---|---|
| Example | Precursor | (g) | (g) | (mL) | (%) |
| PE: XY-1 | PE: X-1 | 9.2 | 11.24 | 300 | 91 |
| PE: XY-2 | PE: X-2 | 3.63 | 5.62 | 200 | 91 |
| PE: XY-3 | PE: X-3 | 3.75 | 5.62 | 200 | 88 |
| PE: XY-4 | PE: X-4 | 10 | 16.86 | 400 | 90 |
| PE: XY-5* | PE: X-5 | 10 | 15 | 200 | N/A |

*Prophetic example with values extrapolated from the working examples.

### Examples 2-4 and Prophetic Example 5

The heteropoly acid was attached to the preparatory example precursors PE:XY-2 through XY-4 using the methods described in Example 1.

| | PE: XY-#: | X: Precursor | Y: DMAc | Z: HPA | α: HCl |
|---|---|---|---|---|---|
| Example | Precursor | (g) | (mL) | (g) | (mL) |
| EX-1 | PE: XY-1 | 5.06 | 100 | 3.65 | 0.565 |
| EX-2 | PE: XY-2 | 2.42 | 25 | 1.31 | 0.203 |
| EX-3 | PE: XY-3 | 2.42 | 25 | 2.6 | 0.402 |
| EX-4 | PE: XY-4 | 5 | 75 | 8.11 | 1.258 |
| EX-5* | PE: XY-5 | 5 | 100 | 8.247 | 1.279 |

*Prophetic example with values extrapolated from the working examples.

### Prophetic Examples

The above-mentioned examples with asterisks (*) are prophetic examples. Furthermore, all the samples that are bound with HPA can be blended with commercial 3M perfluorosulfonic acid (PFSA) ionomers. This experiment will be conducted to optimize the peroxide decomposing function of HPA and proton conductivity of the HPA itself. 5-50 wt % of HPA bound ionomer can be blended with different equivalent weight 3M PFSAs, such as 800EW or 725EW. After the blending, membrane thermal annealing conditions can be varied, too.

### Example 6: Composite Membrane

An example composite membrane was prepared as follows. A suspension of 20 wt-% 3M Ionomer 800EW in 70:30 ethanol to water solvent and a suspension of 8.37 wt-% of PFSA-VDF-HPA in DMAc were prepared at RT and stirred overnight. A mixture of two polymer suspensions in a ratio of 9:1 was made to obtain a 10 wt-% blended polymer suspension. Approximately 10 mL of the blended suspension was cast on a KAPTON liner using a doctor blade with a knife gap of 0.762 mm to fabricate a 100 cm² membrane. The cast suspension was first dried at 100° C. for 15 min followed by thermal annealing at 165° C. for 10 min. The membrane was peeled off the KAPTON liner and then acid-exchanged with 4M sulfuric acid overnight. The membrane was then rinsed with D.I water three times and dried in air overnight.

### Comparative Example 1 CEX-1

A 32-μm membrane of 3M Ionomer 800EW was prepared as described in WO 2011/149732 (Yandrasits et al.) CE—(Electrolyte membrane with no nanofiber mat) without the addition of manganese cations and in a solvent system of 70/30 EtOH/H₂O (w/w). The solution of ionomer was coated onto a polyimide liner with a target dry thickness of 32 μm. The film was further brought to 200° C. to thermally anneal and cooled rapidly to room temperature.

### Test Methods and Material Verification

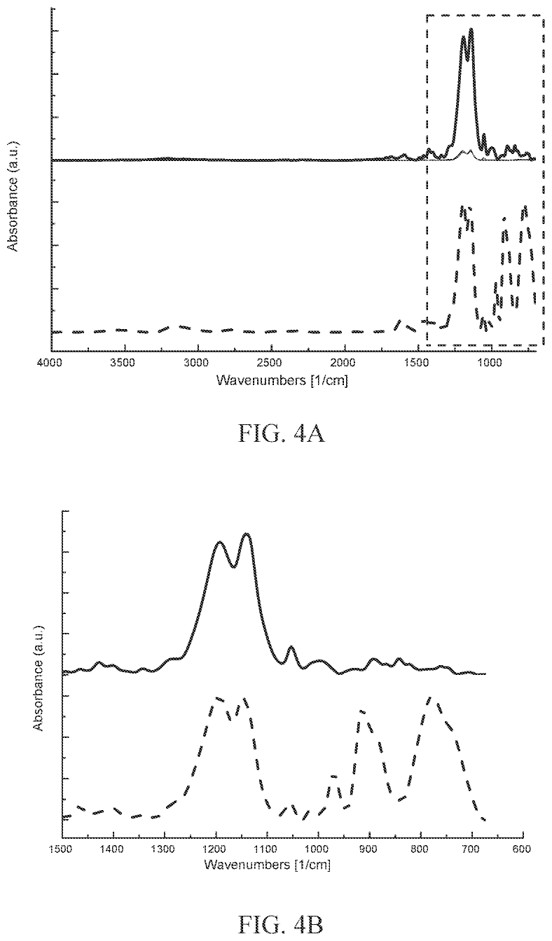

For material verification, representative results for intermediate material PE:X-1 are shown graphically as FTIR (FIG. 4A) and NMR (FIG. 4B) spectra of materials before (FIG. 4, solid line) and after (FIG. 4, dashed line) heteropolyacid attachment.

### Fourier-Transform Infrared Spectroscopy (FT-IR)

The equipment used for FT-IR was a Nicolet Nexus 470 FTIR E.S.P equipped with Specac Golden Gate attenuated total reflection (ATR) stage under room temperature conditions. 512 scans with a resolution of 1 cm⁻¹ was used on membrane or powder forms of the polymer.

The IR spectra on 1130 (asymmetric) and 1200 (symmetric) cm⁻¹ was the result of —CF₂— stretching of the starting material (Howard W. Starkweather et al., Infrared Spectra of Amorphous and Crystalline Poly(tetrafluoroethylene, Macromolecules, 1985, 18, 1684-1686). Due to the domination of —CF₂— stretching bands, aromatic group band was not able to be observed. However, with the covalent attachment of HPA the strong W—O bands between 700 and 1000 cm⁻¹ appeared, which supports the successful attachment of HPA to the starting polymer (Claude Rocchiccioli-Deltcheff et al., Vibrational Investigations of Polyoxometalates. 2. Evidence for Anion-Anion Interactions in Molybdenum(VI) and Tungsten(VI) Compounds Related to the Keggin Structure. Inorg. Chem., 1983, 22, 207-216).

### Nuclear Magnetic Resonance (NMR)

Joel ECA 500 MHz spectrometer and DMSO-d₆ solvent were used to obtain liquid NMR spectra. The chemical shifts for ¹H, ¹⁹F, and ³¹P were based on tetramethylsilane, trichlorofluoromethane, and phosphoric acid standards.

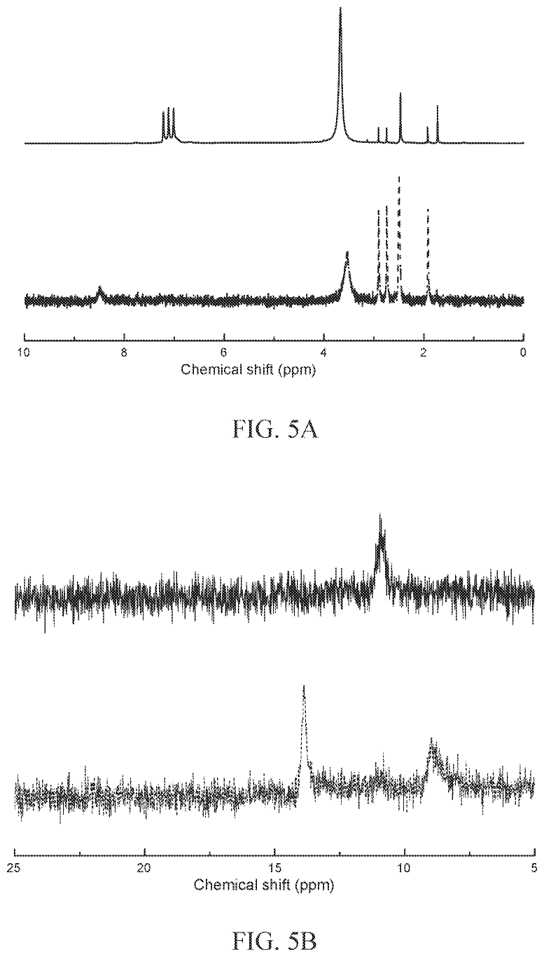

NMR measurement was conducted to validate the covalent attachment of HPA to the starting polymer. ¹H NMR was first used to verify the existence of desired functional groups. For DHPP attached polymer, aromatic protons were observed from 7.0 to 7.2 ppm (FIG. 5A, solid line). ¹P NMR shows more significant evidence of attachment of HPA to the polymer. When DHPP was attached, a sharp peak at 10.8 ppm was observed. When HPA was attached, chemical shift at 53.8 ppm and 8.6 ppm was observed (FIG. 5B, dashed line). 8.6 ppm shifts were more likely chemical shift of phosphorous anhydride and 13.8 ppm shift of two phosphorous attachment to the HPA (A. R. Motz et al., Heteropoly acid functionalized fluoroelastomer with outstanding chemical durability and performance for vehicular fuel cells. Energy & Environmental Science, 2018, 11 (6), 1499-1509).

### Elemental Analysis

Elemental analyses of (EX-6), (PE:XY-1), and (EX-1) were conducted using a flame Atomic Absorption (AA) Spectroscopy to provide a quantitative breakdown of individual elements within a sample (Hoffman Lab, U.S.A). The samples for the analysis were prepared in membrane form and ground prior to the analysis. For PFSA-VDF-HPPA (PE:XY-1), because there was no HPA but only phenol phosphonic acid group bound to the terpolymer, 1.37% w/w (P) was obtained. When HPA was tethered to the terpolymer (PFSA-VDF-HPA (EX-1)), silicon (Si) and tungsten (W) was detected, 0.273 and 2.15% w/w, respectively, due to the covalent binding of the silicotungstic heteropoly acid (α-K₈SiW₁₁O₄₀•13H₂O). Also, when blended with 3M IONOMER 800EW (EX-6) as a 10 wt-% composite membrane, Si, W, and P were detected 0.035, 0.151, 0.0160, respectively.

| | C | H₂ | O₂ | S | Si | K | W | F | P |
|---|---|---|---|---|---|---|---|---|---|
| | (% | (% | (% | (% | (% | (% | (% | (% | (% |
| Sample ID | w/w) | w/w) | w/w) | w/w) | w/w) | w/w) | w/w) | w/w) | w/w) |
| (EX 6) | 18.64 | 0.78 | 13.68 | 3.64 | 0.035 | NR | 0.151 | 22.3 | 0.0160 |
| (PE:XY-1) | 23.52 | 0.89 | 14.21 | 3.37 | NR | NR | NR | 25.3 | 1.37 |
| (EX-1) | 17.75 | 0.89 | 17.15 | 2.14 | 0.273 | NR | 2.15 | 14.9 | 0.351 |

NR = Not Requested

### Thermal Properties

### Thermal Characterization. —

Thermogravimetric analysis of membrane samples that had been pre-dried at room temperature under full vacuum for 24 hours was conducted in nitrogen or air from 0 to 800° C. The results for the PFSA-VDF-HPPA (PE:XY-1), PFSA-VDF-HPA (EX-1), and 10 wt-% composite membrane (EX 6) are described in the table below. Under N₂ environment, in all cases, additional water molecules were lost up to 100° C. (<2%). Up to 200° C. additional mass loss was observed likely due to loss of sulfonic acid groups. When the temperature was ramped up higher than 310° C. a rapid decrease in mass started likely due to the loss of sulfonate sites. Another rapid decrease occurred at 410° C., is consistent with the primary degradation of PVDF (see, S. L.-M. G. Botelho et al., Journal of on-Crystalline Solids, 354, 72 (2008)). Lastly, starting at 480° C., polytetrafluoroethylene (PTFE) backbone decomposition consistent with previous reports was observed (see, A. Kusoglu et al., Chem Rev, 117, 987 (2017); Y. K. S. H. de Almeida, Journal of Thermal Analysis and Calorimetry, 58, 569 (1999); J. R. T. Chalres A. Wilkie et al., Journal of Applied Polymer Science, Vol. 42, 901-909 (1991), 42, 901 (1991)). When the temperature was ramped up to 800° C. under air environment, the elements in the membrane should exist in their most oxidized state. For HPA, the most oxidized form would be 11 WO₃ and 1 SiO₂. 11±2% was the final residue amount after 800° C. oxidization for EX-1.

| | Weight | Weight | Weight | Weight | Weight | Weight |
|---|---|---|---|---|---|---|
| | loss (%) | loss (%) | loss (%) | loss (%) | loss (%) | loss (%) |
| | between | between | between | between | between | between |
| | 0- | 100- | 200- | 310- | 410- | 480- |
| Sample | 100° C. | 200° C. | 310° C. | 410° C. | 480° C. | 800° C. |
| PE:XY-1 | 1.4 (0.9) | 3.3 (3.6) | 6.5 (6.4) | 25.5 (35.0) | 32.40(37.0) | 25.7 (12.9*) |
| EX-1 | 1.9 (1.6) | 1.1 (1.2) | 4.6 (4.5) | 39.3 (50.1) | 20.1 (21.5) | 14.7 (8.6) |
| EX-6 | 1.4 (2.6) | 1.1 (1.6) | 5.2 (2.6) | 15.2 (58.5) | 29.7 (32.7) | 35.0 (0.1) |

*Measured up to 780° C.
Values inside the parenthesis are under air measurements.

### Proton Conductivity

The proton conductivity of the membrane was measured using electrochemical impedance spectroscopy (EIS). The sample was loaded on a four-electrode setup and placed on the TestEquity environmental chamber to control the temperature and relative humidity. The proton conductivity at 80° C. and 80% RH was used as a value to compare different blending ratios, 5, 10, and 20 wt-% (w/w) of PFSA-VDF-HPA (EX-1) to 3M Ionomer 800EW. 5, 10, and 20 wt-% blending ratio composite polymer were tested to get the proton conductivity, 0.029±0.002 S/cm/0.089±0.02 S/cm/0.045±0.02 S/cm, respectively. The conductivity of the 10 wt-% blended polymer was the highest among the samples but still lower than a CEX-1 (0.130±0.03 S/cm).

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A fluorinated ionomer comprising a fluorinated polymer backbone and pendent groups comprising:
covalently bound heteropolyacid groups, or salts thereof, and
covalently bound perfluorosulfonic acid groups, or salts thereof,
wherein the perfluorosulfonic acid groups, or salts thereof, are present in an amount of at least 40 mol % of the total amount of pendent groups.

2. The fluorinated ionomer of claim 1 wherein the pendent groups comprise:
10-39 mol % covalently bound heteropolyacid groups, or salts thereof, and
61-90 mol % covalently bound perfluorosulfonic acid groups, or salts thereof,
wherein the percentages are based on the total amount of pendent groups.

3. The fluorinated ionomer of claim 1 wherein pendent sulfonic acid groups have the structure —[O—CF₂—CF(CF₃)]ᵣ—O—[CF₂]ₛ—SO₃Z, wherein “r” is 0 or 1, and “s” is 1 to 4, and Z is selected from the group of H, Na, K, Li, Ca, Mn, Ce, ammonium, and substituted ammonium (e.g., tetramethyl ammonium).

4. The fluorinated ionomer of claim 1 comprising a moiety having the structure (Formula VII): 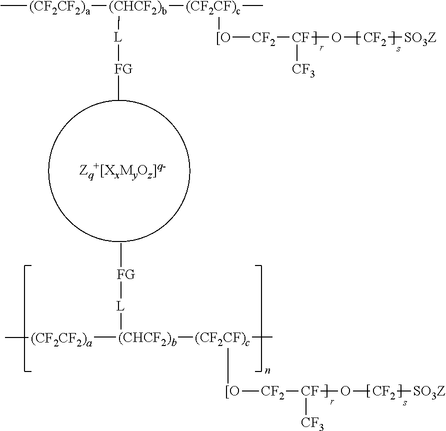
wherein: n is 0, 1, 2, or 3;
FG is a reactive functional group;
L is a linking group;
a is 0 to 80;
b is 1 to 60;
c is 10 to 40;
r is 0 or 1;
s is 1 to 4;
each Z is independently selected from the group of H, Na, K, Li, Ca, Mn, Ce, ammonium, and substituted ammonium;
each X is independently a non-metal heteroatom;
each M is independently a transition metal;
q is 2 to 30;
x is 1 to 3;
y is 5 to 25; and
z is 20 to 130.

5. The fluorinated ionomer of claim 4 wherein the pendent heteropolyacid groups, or salts thereof, are covalently bound to the fluorinated polymer backbone through a phosphorus-containing functional entity.

6. The fluorinated ionomer of claim 5 wherein the phosphorus-containing functional entity is selected from the group of a phosphate, phosphonate, phosphinate, phosphonite, phosphine, and combinations thereof.

7. The fluorinated ionomer of claim 6 wherein the moiety has the following structure (Formula IX): 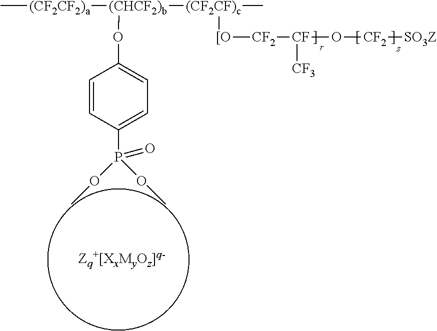
wherein: a is 0 to 80;
b is 1 to 60;
c is 10 to 40;
r is 0 or 1;
s is 1 to 4;
each Z is independently selected from the group of H, Na, K, Li, Ca, Mn, Ce, ammonium, and substituted ammonium;
each X is independently a non-metal heteroatom;
q is 2 to 30;
x is 1 to 3;
y is 5 to 25; and
z is 20 to 130.

8. The fluorinated ionomer of claim 1 having a weight average molecular weight of at least 50,000 grams/mole.

9. A polymer electrolyte membrane comprising the fluorinated ionomer of claim 1.

10. The polymer electrolyte membrane of claim 9 which is a proton exchange membrane.

11. The polymer electrolyte membrane of claim 9 having a thickness of up to 20 micrometers.

12. A fuel cell comprising the polymer electrolyte membrane of claim 9.

13. A method of making the fluorinated ionomer of claim 1, the method comprising:
providing a precursor polymer comprising vinylidene fluoride monomeric units, tetrafluoroethylene monomeric units, and trifluoroethylene monomeric units with pendent groups comprising covalently bound perfluorosulfonyl fluoride groups;
hydrolyzing the perfluorosulfonyl fluoride groups to form covalently bound perfluorosulfonate salt groups;
optionally ion exchanging the perfluorosulfonate groups to form perfluorosulfonic acid groups;
attaching a functional entity (FG-L) to the precursor polymer; and
attaching a lacunary heteropolyacid, or salt thereof, to form covalently bound heteropolyacid groups, or salts thereof to the functional entity.

14. The method of claim 13 wherein hydrolyzing the perfluorosulfonyl fluoride groups occurs at the same time as attaching the functional entity (FG-L).

15. The method of claim 13 wherein hydrolyzing and acidifying the perfluorosulfonyl fluoride groups occurs before attaching the functional entity (FG-L).
